(19) United States
(12) Patent Application Publication
(10) Pub. No.: US 2015/0075380 A1
(43) Pub. Date: Mar. 19, 2015

(54) ACTIVATED-CARBON FILTER WITH STORAGE VOLUME FOR A FUEL TANK

(71) Applicants: Belen Lahaye, Maule (FR); Gilbert Jain, Maintenon (FR); Caroline Lapierre, Itteville (FR); Aurelien Monvoisin, Renwez (FR)

(72) Inventors: Belen Lahaye, Maule (FR); Gilbert Jain, Maintenon (FR); Caroline Lapierre, Itteville (FR); Aurelien Monvoisin, Renwez (FR)

(73) Assignee: RENAULT s.a.s., Boulogne-Billancourt (FR)

(21) Appl. No.: 14/344,752

(22) PCT Filed: Sep. 10, 2012
(86) PCT No.: PCT/FR2012/052016

§ 371 Date: Nov. 4, 2014

(30) Foreign Application Priority Data
Sep. 13, 2011 (FR) 11 58124

(51) Int. Cl. B60K 15/035; F02M 25/08; B60K 15/03; B01D 53/04

(52) U.S. Cl. CPC B60K 15/03504; B01D 53/0415; F02M 25/0854; F02M 25/0836; B60K 15/03; B01D 2253/102; B01D 2257/702; B60K 2015/03236; B60K 2015/03514
USPC 96/121; 96/108

(57) ABSTRACT

An activated carbon filter for a fuel tank supplying a heat engine of an automobile, the carbon filter including a housing including an inlet port capable of being connected to the fuel tank, a discharge port capable of being connected to the heat engine, and a vent port. The housing includes at least one internal wall dividing the inner volume thereof into at least two intercommunicating chambers, at least one activated carbon chamber containing activated carbon capable of trapping hydrocarbon gases, and a storage chamber forming a storage volume of a gas stream entering through the inlet port of the housing.

The invention relates to an activated-carbon filter with a storage tank for a fuel tank.

Liquid-fuel tanks, in particular for motor vehicles, usually have a breather orifice enabling the internal pressure and atmospheric pressure to be equalized, for example when the fuel level changes as a result of the tank being filled or the fuel being used by the engine, or in the event of temperature changes.

There are a number of solutions used to ensure compliance with pollution regulations and to limit atmospheric emissions of hydrocarbon fumes.

A first solution, often used for hybrid motor vehicles, i.e. vehicles including heat and electric propulsion systems, involves closing the fuel tank using a calibrated valve. The fuel tank is then pressurized, which makes it more complex and expensive to build, as well as requiring means for opening and closing the valve.

A second solution involves fitting motor vehicles with a filter that traps and stores these fumes from the tank before recycling them in the engine. These filters, known as “canisters”, usually comprise a housing containing activated carbon. The recycling of fumes from the tank in the heat engine by purging the activated-carbon filter is controlled by a management system. Such purges must be performed regularly to ensure the filter works correctly.

Such filters may be used both in heat-engine vehicles and hybrid-engine vehicles. However, the heat engine in hybrid vehicles may not operate for several days in a row, or the operating mode of the heat engine may not command the filter to be purged, such that said filter is not purged for several days, which may result in emissions of hydrocarbon fumes into the atmosphere in contravention of pollution regulations.

To overcome this problem, a solution described in document WO2011/020627A1 involves providing an additional fume-storage tank located between the tank and the carbon filter, and outside the latter. This solution is nonetheless relatively cumbersome and may be difficult to implement, in particular in a hybrid vehicle in which the batteries and the electric motor occupy a significant volume. This solution is also relatively complex and requires pipes linking the additional tank to the fuel tank and to the activated-carbon filter, and valves isolating the additional tank, which increases the risks of leaks from the whole.

There is therefore a need for an activated-carbon filter of simple design and limited size that nonetheless provides high storage capacity, enabling compliance with prevailing regulations.

For this purpose, a first subject of the invention is an activated-carbon filter for a fuel tank supplying a heat engine of a motor vehicle, said carbon filter comprising a casing fitted with an input orifice that can be connected to said fuel tank, a purge orifice that can be connected to said heat engine and a breather orifice, characterized in that said casing includes at least one internal wall dividing the internal volume thereof into at least two chambers communicating with one another, at least one activated-carbon chamber containing the activated carbon able to trap gaseous hydrocarbons, and a storage chamber forming a storage volume for a gas flow entering via the input orifice of the casing.

Notably, the casing has at least two internal walls.

A first internal wall divides the internal volume thereof into at least two chambers communicating with one another, at least one activated-carbon chamber containing the activated carbon able to trap gaseous hydrocarbons, and a storage chamber forming a storage volume for a gas flow entering via the input orifice of the casing.

A second internal wall extends longitudinally such as to separate the purge orifice from at least one of the input and breather orifices.

The activated-carbon filter according to the invention therefore has a storage volume built into the casing of the filter, which saves space and simplifies assembly, this solution not requiring any pipes or valves to isolate the storage volume. The activated-carbon filter according to the invention is also less liable to leaks than a system incorporating an additional separate tank and a set of valves and pipes to connect this additional tank to the filter and/or to the fuel tank.

Furthermore, the presence of a storage chamber enables the saturation time of the activated-carbon filter to be delayed, thereby delaying the moment at which the activated-carbon filter has to be purged. The activated-carbon filter according to the invention can therefore be used in heat-engine vehicles to increase the saturation time if pollution regulations are made more stringent, or can be used to ensure compliance with these regulations when used in hybrid-engine vehicles.

The volume of the storage chamber may in particular be determined as a function of a target number of days before saturation of the activated carbon contained in the activated-carbon chamber or chambers. This number of days may be defined by prevailing regulations and may be from 1 to 3 days. The car manufacturer may also choose to increase the number of days as a function of the anticipated use of the heat engine.

This storage volume inside the casing of the activated-carbon filter also allows less activated carbon to be used when compared to a conventional activated-carbon filter of equal casing volume (without internal storage volume), while keeping the saturation time constant. It is therefore possible to reduce costs, since activated carbon is relatively expensive, which may be beneficial, in particular for heat-engine vehicles.

Advantageously, said storage chamber is placed upstream of an activated-carbon chamber in relation to the gas flow entering via the input orifice and exiting via the breather orifice. This arrangement requires the gas flow entering the activated-carbon filter to fill the storage chamber before passing through the activated carbon, delaying entry of the gas flow into the activated-carbon chamber, which delays saturation of the activated carbon.

Specifically, the casing of the activated-carbon filter may include at least two activated-carbon chambers containing activated carbon, said storage chamber being placed upstream of one activated-carbon chamber and downstream of another activated-carbon chamber in relation to the gas flow entering via the input orifice and exiting via the breather orifice. Notably, this arrangement enables different types of activated carbon to be used in the two activated-carbon chambers, thereby improving adsorption of the hydrocarbon gas flows. It also helps to reduce pressure drops through the activated-carbon filter, enabling more activated carbon to be used than in the embodiment described below.

Advantageously, if the activated-carbon filter according to the invention includes at least one activated-carbon chamber and at least one storage chamber, and in particular one activated-carbon chamber and one storage chamber, the activated-carbon chamber and the storage chamber are separated by a gas-impermeable internal wall that extends along most of the length of the casing, the input orifice of the casing leading to one extremity of the storage chamber along the length of said casing and said storage chamber communicating with the activated-carbon chamber at an extremity opposite said input orifice.

This arrangement enables the input orifice of the activated-carbon filter to be placed in a low position when it is connected to the fuel tank, the longitudinal axis of the carbon filter being for example close to vertical, enabling any condensed fuel vapors to return to the fuel tank.

To provide a gas flow path inside the activated-carbon chamber, an internal gas-impermeable wall may be placed inside this chamber, extending along some of the length of the casing, in particular from the purge orifice side.

The purge orifice usually communicates with the activated-carbon chamber. For example, the input orifice and the purge orifice of the casing may be arranged at opposing extremities of the casing along the length of the casing.

The breather orifice also usually communicates with the activated-carbon chamber. For example, it may be located on the same extremity of the casing as the purge orifice of the casing or on the extremity of the casing opposite the extremity with the purge orifice of the casing.

In the latter case, the breather orifice may then be placed in a low position of the activated-carbon filter, if the longitudinal axis of the latter is close to vertical when in use.

In this case, water may penetrate this breather orifice, which may disturb operation or purging of the activated-carbon filter. To overcome this drawback, the breather orifice may lead to another chamber separated from the activated-carbon chamber by a gas-impermeable wall extending along most of the length of the casing, one extremity of said other chamber being connected to the activated-carbon chamber via the breather orifice, and the other extremity of this other chamber communicating with the atmosphere.

Furthermore, the volume of this other chamber may be used to contain a supplementary adsorbent agent to improve the gas hydrocarbon retention of the activated-carbon filter.

If the activated-carbon filter according to the invention includes at least two activated-carbon chambers, and in particular two activated-carbon chambers, the two activated-carbon chambers may be separated by a gas-impermeable internal wall extending along the length of the casing as far as a gas-permeable transverse internal wall extending along the entire width of the casing. This arrangement has the advantage of being particularly compact, enabling it to be used in hybrid-engine vehicles. It also enables the use of different types of activated carbon in each of the chambers and causes limited pressure drops.

The gas-permeable internal wall may for example also be used to support the activated carbon contained in each of the activated-carbon chambers. For this purpose, it may be held in position by pressurizing means, such as springs.

Another subject of the invention is a motor vehicle with a heat engine supplied by a fuel tank, and incorporating an activated-carbon filter according to the invention.

The invention is described below with reference to the attached drawings, which are non-limiting, in which:

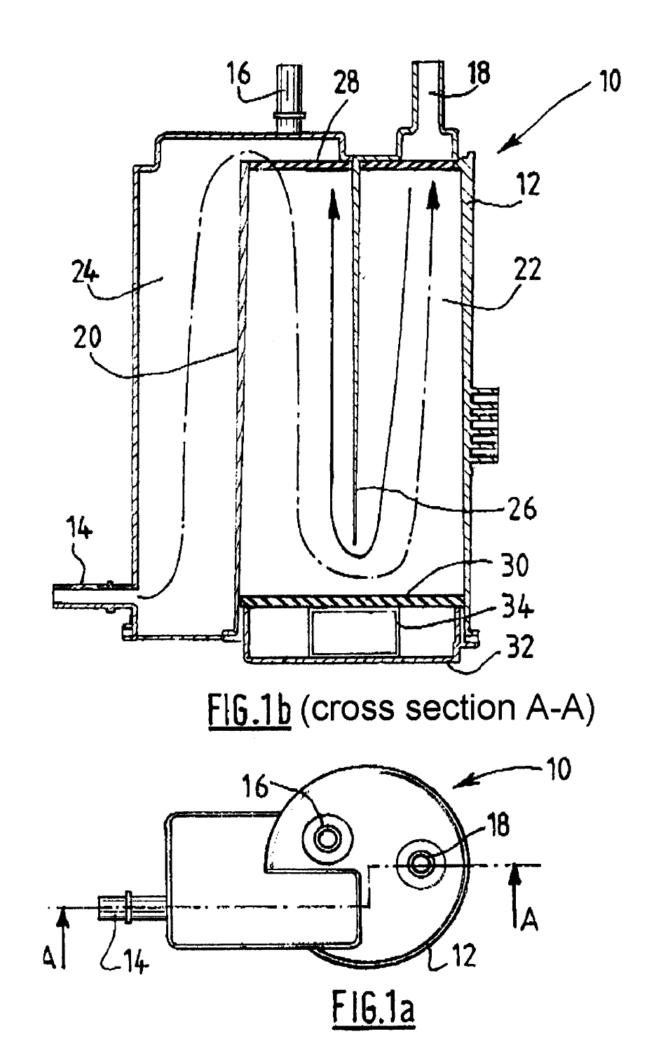

FIG. 1a is a top view of an activated-carbon filter according to the invention,

FIG. 1b is a cross-section taken from FIG. 1a along the line A-A in FIG. 1a,

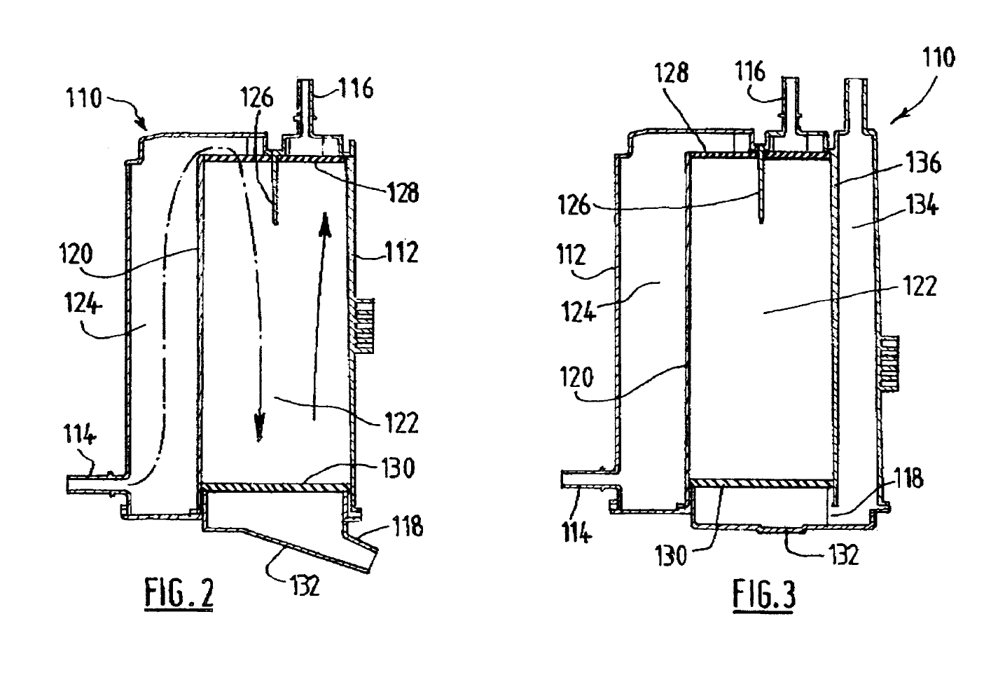

FIG. 2 is a cross-section similar to FIG. 1b of another embodiment of the invention,

FIG. 3 is a cross-section similar to FIG. 1b according to another embodiment of the invention,

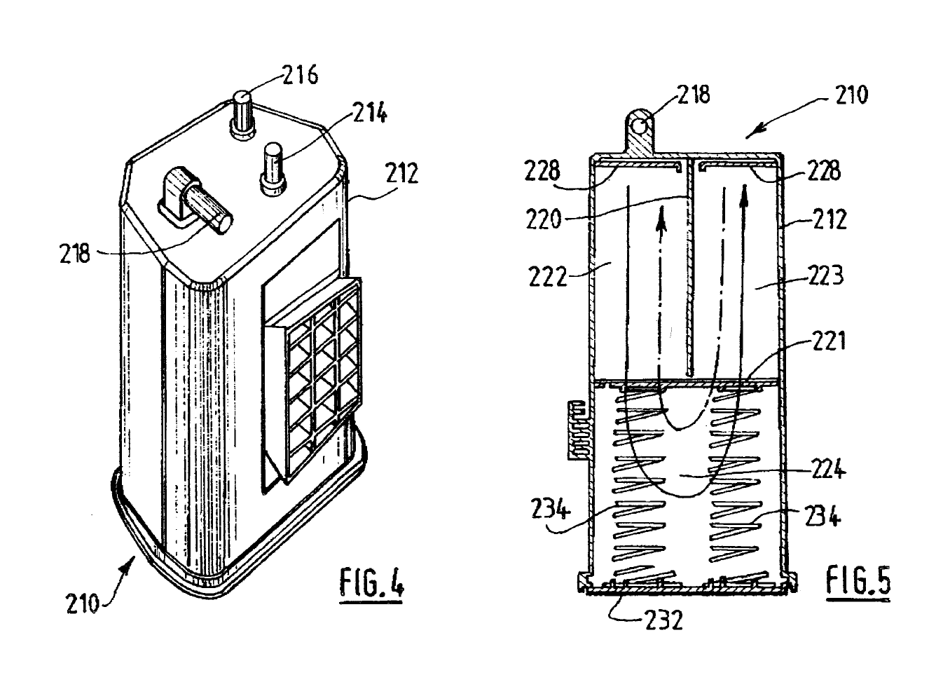

FIG. 4 is a perspective view of another embodiment of the invention,

FIG. 5 is a cross-section of the embodiment shown in FIG. 4.

The terms “upper” and “lower” relate to a vertical position of the carbon filter, i.e. when the longitudinal axis of the carbon filter is vertical.

FIG. 1a shows an activated-carbon filter 10 for a fuel tank supplying a heat engine of a motor vehicle.

This activated-carbon filter 10 includes a casing 12 fitted with an input orifice 14 that can be connected to said fuel tank. The casing 12 is also fitted with a purge orifice 16 that can be connected to a heat engine, and a breather orifice 18.

According to the invention, the casing 12 includes at least one internal wall dividing the internal volume thereof into at least two chambers communicating with one another.

In the example shown in FIGS. 1a and 1b, an internal wall 20 separates the internal volume of the casing into an activated-carbon chamber 22 and a storage chamber 24 forming a storage volume for a gas flow entering via the input orifice 14 of the casing.

The activated-carbon filter 10 is arranged such that the storage chamber 24 is placed upstream of the activated-carbon chamber 22 in relation to the gas flow entering via the input orifice 14 and exiting via the breather orifice 18.

In the example shown, the activated-carbon chamber 22 has a generally cylindrical shape, while the storage chamber 24 has a general parallelepiped rectangle shape (FIG. 1a). The invention is however not limited to these specific shapes.

The internal wall 20 separating the two chambers 22, 24 is a gas-impermeable wall that extends along most of the length of the casing 12.

“Most” means that this wall 20 extends along 80% of the length of the casing, or even along 90-95% of the length of the casing 12.

The input orifice 14 of the casing 12 leads to one extremity of the storage chamber 24 along the length of the casing 12, located in the lower zone of the casing 12 in the example.

The storage chamber 24 communicates with the activated-carbon chamber 22 at an extremity opposite this input orifice 14, in the upper zone of the casing 12. The breather orifice 18 and the purge orifice 16 are located at the same extremity of the casing 12, opposite the input orifice 14.

In the example shown, the activated-carbon chamber 22 is also separated substantially into two by an internal wall 26 extending along most of the length of the casing from the extremity of the activated-carbon chamber 22 connected to the breather orifice 18 and the purge orifice 16. This wall 26 extends longitudinally between the purge orifice 16 and the breather orifice 18 (FIG. 1b).

The activated carbon contained in the activated-carbon chamber 22 is held in position by means of gas-permeable walls 28, 30. These may be perforated plates or grilles, for example.

These perforated plates or grilles 28, 30 are arranged substantially perpendicular to the longitudinal axis of the casing 12. The upper grille 28 is preferably fixed while the lower grille 30 is removable and held in position by a cover 32 and a retaining spring 34 located between the cover 32 and this lower grille 30.

The purge orifice 16 and the breather orifice 18 are arranged above the grille 28 along the length of the casing, such that the activated-carbon chamber communicates with these two orifices. The internal wall 20 stops level with the grille 28, thereby communicating the storage chamber 24 with the activated-carbon chamber 22.

The activated-carbon filter shown in FIGS. 1a and 1b works as follows:

During the charging phases (broken-line arrow), the fumes from the fuel tank enter via the input orifice 14 and fill the storage chamber 24, before entering the activated-carbon chamber 22 via the grille 28 and passing through the activated-carbon chamber 22 along a substantially U-shaped path as far as the breather orifice 18.

During the purge phases of the activated-carbon filter, the fumes move in the opposite direction (following the solid-line arrow) to the purge orifice 16.

The embodiment shown in FIG. 2 differs from the embodiment shown in FIG. 1 in the position of the purge orifice and of the breather orifice.

In this embodiment, the activated-carbon filter 110 includes a casing 112, an input orifice 114, a purge orifice 116, and a breather orifice 118. An internal wall 120 separates the inside of the volume of the casing 112 into an activated-carbon chamber 122 and a storage chamber 124. The input orifice 114 is located at a lower extremity of the casing 112, while the purge orifice 116 is located at the opposite extremity of the casing 112. The breather orifice 118 is located on the extremity opposite the purge orifice 116, beneath the activated-carbon chamber 122.

Plates 128, 130 hold the activated carbon placed inside the activated-carbon chamber 122, and the entire surface area of the lower grille 130 leads to the breather orifice 118, which may be formed in a cover 132.

The internal wall 120 stops level with the grille 128, thereby communicating the storage chamber 124 with the activated-carbon chamber 122.

An internal wall 126 extends longitudinally inside the activated-carbon chamber 122 for a short distance from this grille 128, such as to separate the purge orifice 116 and the communicating passage between the storage chamber 124 and the activated-carbon chamber 122. This internal wall 126 extends for example along at least half of the length of the casing, or at least one third or at least one quarter of this length.

On the upper extremity of the casing 112, the grille 128 thus leads from one side of the internal wall 126 to the storage chamber 124, and from the other side of the internal wall 126 to the purge orifice 116, which is arranged above the grille 128 along the length of the casing, thereby ensuring communication with the activated-carbon chamber 122.

The activated-carbon filter shown in FIG. 2 works as follows:

During the charging phases, the fumes move from the input orifice 114 filling the storage chamber 124, then enter the activated-carbon chamber 122 via the left-hand side of the grille 128, and pass through the entire length of this activated-carbon chamber 122 as far as the breather orifice 118 (flow represented by a broken-line arrow).

During the purge phases (solid-line arrow), the fumes move in the opposite direction and pass through the entire length of the activated-carbon chamber 122 from the breather orifice 118 to the purge orifice 116.

FIG. 3 shows an embodiment very similar to the embodiment shown in FIG. 2. As a result, the same reference signs have been used to indicate the same elements.

The only difference with the embodiment shown in FIG. 2 is that the breather orifice 118 leads to a chamber 134 separated from the activated-carbon chamber 122 by a gas-impermeable wall 136. This gas-impermeable wall 136 extends along most of the length of the casing. One extremity of this chamber 134 is therefore connected to the activated-carbon chamber via the breather orifice 118, while the other extremity of this chamber 134 communicates with the atmosphere, on the upper side of the casing 112 close to the purge orifice 116.

The carbon filter shown in FIG. 3 works identically to the one shown in FIG. 2.

FIGS. 4 and 5 show an activated-carbon filter 210 comprising a casing 212 fitted with an input orifice 214, a purge orifice 216 and a breather orifice 218 on the upper extremity thereof.

A gas-impermeable internal wall 220 extends along the length of the casing 212 as far as a gas-permeable transverse internal wall 221 extending along the entire width of the casing 212.

The internal wall 220 separates the upper part of the casing into two activated-carbon chambers 222, 223.

The transverse internal wall 221 separates these two activated-carbon chambers 222, 223 from a storage chamber 224 occupying the lower volume of the casing 212. The breather orifice 218 leads to the upper part of one of the activated-carbon chambers 222, the input orifice 214 and the purge orifice 216 leading to the upper part of the other carbon chamber 223.

Two transverse grilles 228 separate the activated carbon contained in each activated-carbon chamber 222, 223 from the orifices leading thereto.

The transverse internal wall 221 also supports the activated carbon contained in the activated-carbon chambers 222, 223. For this purpose, retaining elements 234, such as springs, located between a cover 232 and this internal wall 221 hold the latter against the internal wall 220.

In this example, the volume of the storage chamber 224 represents substantially half of the volume of the two activated-carbon chambers 222, 223.

The activated-carbon filter 210 shown in FIGS. 4 and 5 works as follows:

During the charging phases (broken-line arrow), the fumes move from the input orifice 214 via an activated-carbon chamber 223, then pass through the internal wall 221 and fill the storage chamber 224 before penetrating the other activated-carbon chamber 224 as far as the breather orifice 218.

During the purge phases (solid-line arrow), the fumes move in the opposite direction from the breather orifice 218 to the purge orifice 216.

All types of activated carbon can be placed in the activated-carbon chambers of the filter according to the invention.

1-10. (canceled)

11. An activated-carbon filter for a fuel tank supplying a heat engine of a motor vehicle, the carbon filter comprising:
a casing fitted with an input orifice that can be connected to the fuel tank;
a purge orifice that can be connected to the heat engine and a breather orifice;
wherein the casing includes:
a first internal wall dividing an internal volume thereof into at least two chambers communicating with one another, at least one activated-carbon chamber containing the activated carbon able to trap gaseous hydrocarbons, and a storage chamber forming a storage volume for a gas flow entering via the input orifice of the casing; and
a second internal wall extending longitudinally to separate the purge orifice from at least one of the input and breather orifices.

12. The activated-carbon filter as claimed in claim 11, wherein the storage chamber is placed upstream of the activated-carbon chamber in relation to the gas flow entering via the input orifice and exiting via the breather orifice.

13. The activated-carbon filter as claimed in claim 11, wherein the casing includes at least two activated-carbon chambers containing activated carbon, the storage chamber being placed upstream of one activated-carbon chamber and downstream of another activated-carbon chamber in relation to the gas flow entering via the input orifice and exiting via the breather orifice.

14. The activated-carbon filter as claimed in claim 12, wherein the activated-carbon chamber and the storage chamber are separated by a gas-impermeable internal wall that extends along most of the length of the casing, the input orifice of the casing leading to one extremity of the storage chamber along the length of the casing and the storage chamber communicating with the activated-carbon chamber at an extremity opposite the input orifice.

15. The activated-carbon filter as claimed in claim 14, wherein the purge orifice communicates with the activated-carbon chamber, and the input orifice and the purge orifice of the casing are arranged at opposing extremities of the casing along the length of the casing.

16. The activated-carbon filter as claimed in claim 14, wherein the breather orifice communicates with the activated-carbon chamber and is located on the same extremity of the casing as the purge orifice of the casing.

17. The activated-carbon filter as claimed in claim 14, wherein the breather orifice communicates with the activated-carbon chamber and is located on the extremity of the casing opposite the extremity with the purge orifice of the casing.

18. The activated-carbon filter as claimed in claim 17, wherein the breather orifice leads to another chamber separated from the activated-carbon chamber by a gas-impermeable wall extending along most of the length of the casing, one extremity of the other chamber being connected to the activated-carbon chamber via the breather orifice, and the other extremity of this other chamber communicating with the atmosphere.

19. The activated-carbon filter as claimed in claim 13, wherein the two activated-carbon chambers are separated by a gas-impermeable internal wall extending along the length of the casing as far as a gas-permeable transverse internal wall extending along the entire width of the casing.

20. A motor vehicle with a heat engine supplied by a fuel tank, comprising an activated-carbon filter as claimed in claim 11.
